(19) United States
(12) Patent Application Publication
(10) Pub. No.: US 2016/0052247 A1
(43) Pub. Date: Feb. 25, 2016

(54) MANUFACTURING PROCESS FOR VACUUM HEAT TRANSFER PRINTING AND JIG THEREOF

(71) Applicants: Wan-Li Chuang, Taipei City (TW); Kuo-Nan Ling, Taipei City (TW); Po-An Lin, Taipei City (TW)

(72) Inventors: Wan-Li Chuang, Taipei City (TW); Kuo-Nan Ling, Taipei City (TW); Po-An Lin, Taipei City (TW)

(73) Assignee: COMPAL ELECTRONICS, INC., Taipei City (TW)

(21) Appl. No.: 14/599,530

(22) Filed: Jan. 18, 2015

(30) Foreign Application Priority Data
Aug. 22, 2014 (TW) 103128973

(51) Int. Cl. B32B 37/00; B32B 37/16

(52) U.S. Cl. CPC B32B 37/0053; B32B 37/16; B32B 2307/75; B32B 2309/68

(57) ABSTRACT

A manufacturing process for vacuum heat transfer printing is used for transfer printing a pattern of a film onto a main surface of a workpiece. The manufacturing process for vacuum heat transfer printing includes: disposing the workpiece and the film in a mold cavity, wherein the film is located above the main surface of the workpiece, and the main surface is divided into a plurality of blocks; heating the mold cavity; and providing different negative pressures into the mold cavity corresponding to each of the blocks, such that the film is vacuumed onto the blocks in sequence and the patterns are transfer printed onto the main surface of the workpiece in sequence. A jig for the manufacturing process for vacuum heat transfer printing is also provided.

### CROSS-REFERENCE TO RELATED APPLICATION

This application claims the priority benefit of Taiwan application serial no. 103128973, filed on Aug. 22, 2014. The entirety of the above-mentioned patent application is hereby incorporated by reference herein and made a part of this specification.

### FIELD OF THE INVENTION

The invention relates to a manufacturing process for transfer printing and a jig thereof. More particularly, the invention relates to a manufacturing process for vacuum heat transfer printing and a jig thereof.

### DESCRIPTION OF RELATED ART

Currently, metallic materials are usually adopted to be materials for appearance components of many electronic devices, such as notebook computers, mobile phones or digital cameras. In order to enhance the overall aesthetics of the electronic device and attract attention of consumers, a variety of patterns are often formed on the appearance components.

Existing methods for forming patterns on surfaces of the metallic materials are usually carried out by etching the metallic materials with a solvent, or by spraying and transfer printing. However, the surface treatment technology for the former is complicated and is stymied by high degrees of difficulty, and the process thereof causes high pollution, while the latter is limited to the chemical properties of the metallic materials, such that a preferable appearance could not be achieved. Take the injection molding casing made of magnesium alloy as an example, an appearance obtaining a primitive color of metal luster cannot be exhibited on a surface of the casing due to high chemical activity and due to that polishing and mending are still required during surface processing.

Namely, various surface profiles having undulations are presented to meet needs for use or visual effects, which make formations of various types of patterns on surfaces more challenging.

### SUMMARY OF THE INVENTION

The invention provides a manufacturing process for vacuum heat transfer printing and a jig thereof, such that a three-dimensional pattern of a film may successfully be transfer printed onto a workpiece having a surface with various profiles.

A manufacturing process for vacuum heat transfer printing of the invention is used for transfer printing a pattern of a film onto a main surface of a workpiece. The manufacturing process for vacuum heat transfer printing includes: disposing the workpiece and the film in a mold cavity, and the film is located above the main surface, wherein the main surface includes a plurality of blocks; heating the mold cavity; and providing different negative pressures into the mold cavity by corresponding to each of the blocks, such that the film is vacuumed onto the blocks in sequence and the pattern is gradually transfer printed onto the main surface of the workpiece in sequence.

A jig of the invention is adapted for the manufacturing process for vacuum heat transfer printing. The jig is configured to be disposed in the mold cavity. The jig includes a first component and at least a second component. The first component has a first outgassing aperture and a plurality of first trenches. The second component is detachably assembled to the first component, such that the trenches and the second component form a plurality of air flues which are connected to the outgassing apertures. The workpiece is adapted to be carried on the second component. A vacuum unit is adapted to be connected to the first outgassing aperture and provide negative pressures into the mold cavity through the air flues, such that the film corresponds to the blocks and is attached to the workpiece.

In an embodiment of the invention, the main surface is divided into a plurality of blocks according to relative heights thereof in the mold cavity, and portions of the main surface located in the same block have the same relative heights.

In an embodiment of the invention, the main surface is divided into a plurality of blocks according to distances thereof with respect to the film, and portions of the main surface located in the same block have the same distance with respect to the film.

In an embodiment of the invention, the film divides the mold cavity into a first space and a second space. The workpiece is located in the second space, and the negative pressures are provided into the second space.

In an embodiment of the invention, the main surface includes a first block and a second block. Beside, the manufacturing process for vacuum heat transfer printing further includes: providing a first negative pressure into a second space, such that the film is vacuumed onto the first block before the pattern is transfer printed onto the first block, and a subspace is formed between the second block and the film; and providing a second negative pressure into a subspace, such that the film is vacuumed onto the second block for the pattern to be transfer printed onto the second block.

In an embodiment of the invention, when a negative pressure is provided into the second space, the film is vacuumed onto one of the blocks of the main surface for the pattern is transfer printed onto the block, and a plurality of subspaces are formed between the film and other un-vacuumed blocks. The manufacturing process for vacuum heat transfer printing further includes: providing different negative pressures into the subspaces according to sizes of each of the subspaces, such that the film is vacuumed onto the corresponding block for the pattern to be transfer printed onto the block.

In an embodiment of the invention, the manufacturing process for vacuum heat transfer printing further includes: providing different negative pressures into the subspaces in sequence according to the sizes of each of the subspaces from large to small.

In an embodiment of the invention, the second space and the subspaces are airtight spaces, respectively.

In an embodiment of the invention, the provided negative pressure is in direct proportions to the sizes of the subspaces.

An embodiment of the invention further includes providing a positive pressure into the first space so as to assist the film to be vacuumed onto the workpiece.

In an embodiment of the invention, the workpiece further includes at least a lateral surface which adjoins to the main surface, and relative heights of the lateral surface in the mold cavity or distances thereof with respect to the film represent gradient changes. The manufacturing process for vacuum heat transfer printing further includes: after the film is vacuumed onto and transfer prints a pattern onto the main surface of the workpiece, another negative pressure is provided for the film to be vacuumed onto and transfer print a pattern onto the lateral surface of the workpiece.

In an embodiment of the invention, the film divides the mold cavity into a first space and a second space. The workpiece is located in the second space, and the negative pressure is provided into the second space. The manufacturing process for vacuum heat transfer printing further includes: providing a positive pressure into the first space to assist the film to be vacuumed onto the lateral surface of the workpiece.

In an embodiment of the invention, the main surface is divided into a plurality of blocks according to relative heights thereof in the mold cavity, and portions of the main surface located in the same block have the same relative height. The jig includes a plurality of second components. The second components respectively correspond to the blocks according to relative heights thereof in the mold cavity.

In an embodiment of the invention, the main surface is divided into a plurality of blocks according to distances thereof with respect to the film, and portions of the main surface located in the same block have the same distance with respect to the film. The jig includes a plurality of second components. The second components respectively correspond to the blocks according to distances thereof with respect to the film.

In an embodiment of the invention, the jig includes a plurality of second components (A₁, A₂), wherein the second component (A₁) has a first opening, and the second component (A₂) is detachably assembled to the first component and accommodated in the first opening. The second component (A₂) has a plurality of second trenches and a second outgassing aperture which are connected to a vacuum unit. The second outgassing aperture passes through the first component. The second components (A₁, A₂) respectively correspond to the different blocks of the workpiece.

In an embodiment of the invention, a relative height of the second component (A₂) in the mold cavity is lower than a relative height of the second component (A₁) in the mold cavity, or a distance of the film with respect to the second component (A₁) is shorter than a distance of the film with respect to the second component (A₂). When the film is attached to the second component (A₁), an airtight space is formed between the film and the second component (A₂).

In an embodiment of the invention, the jig includes a plurality of second components (A₁, A₂, A₃), wherein the second component (A₁) has a first opening and a second opening. The second component (A₂) is detachably assembled to the first component and accommodated in the first opening. The second component (A₃) is detachably assembled to the first component and accommodated in the second opening. The second component (A₂) has a plurality of second trenches and a second outgassing aperture which are connected to a vacuum unit. The second component (A₃) has a plurality of third trenches and a third outgassing aperture which are connected to a vacuum unit. The second and third outgassing apertures pass through the first component, respectively. The second components (A₁, A₂, A₃) correspond to the different blocks of the workpiece, respectively.

In an embodiment of the invention, a relative height of the second component (A₂) in the mold cavity is lower than a relative height of the second component (A₁) in the mold cavity, or a distance of the film with respect to the second component (A₁) is shorter than a distance of the film with respect to the second component (A₂). Besides, a relative height of the second component (A₃) in the mold cavity is lower than the relative height of the second component (A₂) in the mold cavity, or the distance of the film with respect to the second component (A₂) is shorter than a distance of the film with respect to the second component (A₃). When the film is attached to the second component (A₁), an airtight space is formed between the film and the second component (A₂). When the film is attached to the second component (A₂), an airtight space is formed between the film and the second component (A₃).

In view of the above, in order to cope with different profiles with various degrees of undulation which are presented on a main surface of a workpiece, the main surface of the workpiece is divide into a plurality of blocks in the manufacturing process for vacuum heat transfer printing of the invention. Besides, the corresponding negative pressures are further provided into each of the blocks for the film to be attached to and vacuumed onto the blocks in sequence, such that the pattern of the film is gradually transfer printed onto the main surface.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a manufacturing process for vacuum heat transfer printing in an embodiment of the invention.

FIG. 2 to FIG. 6 are schematic views illustrating related components by corresponding to the manufacturing process depicted in FIG. 1.

FIG. 7 is a detailed flow chart illustrating the step S130 of the manufacturing process depicted in FIG. 1.

FIG. 8 is a schematic view illustrating a manufacturing process for vacuum heat transfer printing in another embodiment of the invention.

FIG. 9 is a schematic view illustrating a workpiece being carried on a jig depicted in FIG. 2.

FIG. 10 is an exploded view illustrating the workpiece and the jig depicted in FIG. 9 from another viewing angle.

FIG. 11 is a partial enlarged view of C1 depicted in FIG. 2.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

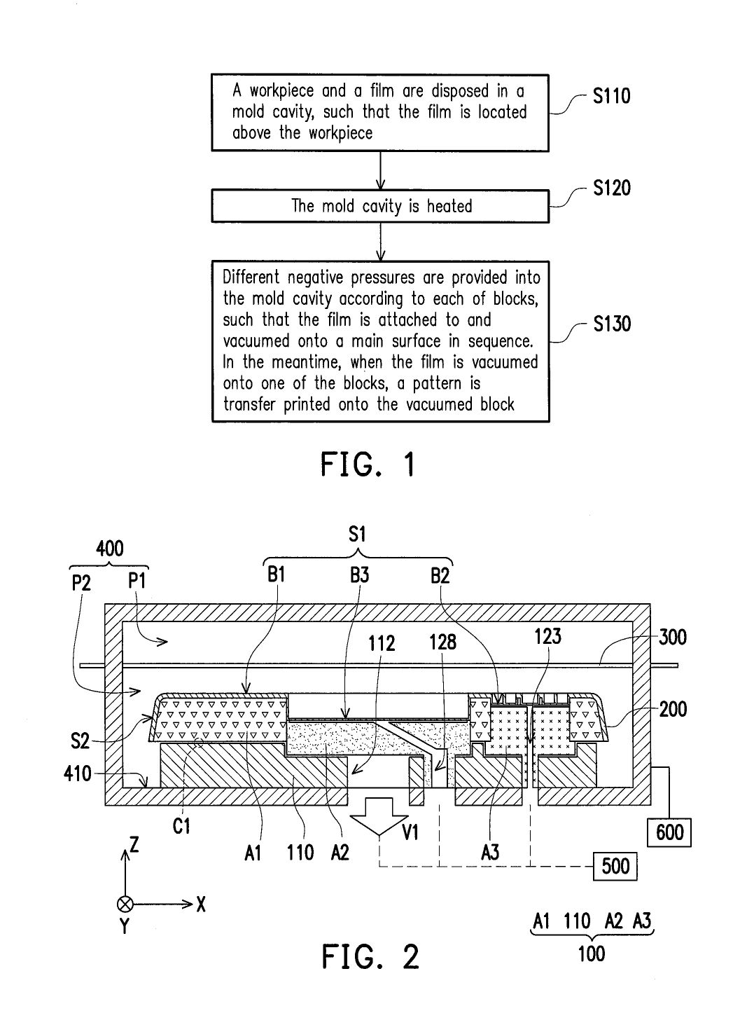

FIG. 1 is a flow chart illustrating a manufacturing process for vacuum heat transfer printing in an embodiment of the invention. FIG. 2 to FIG. 6 are schematic views illustrating related components by corresponding to the manufacturing process depicted in FIG. 1. First, with reference to FIG. 1 and FIG. 2, in a step S110 of the present embodiment, a workpiece 200 and a film 300 are disposed in a mold cavity 400, and the workpiece 200 is carried on a jig 100, wherein the workpiece 200 has a main surface S1, and the film 300 is located above the main surface S1. As illustrated in FIG. 2, the main surface S1 of the work piece 200 is categorized based on its surface profile or undulation state. Here, the main surface S1 of the present embodiment is divided into blocks B1, B2, and B3 according to relative heights of the main surface S1 in the mold cavity 400, and surfaces of the same block indicate that the surfaces have the same relative heights, but the invention is not limited thereto. In other words, in the present embodiment, a bottom 410 of the mold cavity 400 is deemed as a reference, and heights of the main surface S1 with respect to the bottom 410 are defined as relative heights of the main surface S1 in the mold cavity 400, thereby the main surface S1 is divided into the blocks B1, B2, and B3 which have different relative heights. In the mold cavity 400, the relative height of the block B1 is higher than the relative height of the block B2, and the relative height of the block B2 is higher than the relative height of the block B3.

In addition, it should be noted that the main surface S1 of the invention is not divided on the basis of the aforesaid. In an embodiment not illustrated in the invention, different blocks may be divided by distances of the film 300 with respect to the main surface S1, and surfaces of the same block with respect to the film 300 have the same distance. For example, FIG. 2 is also taken as an example, the distance of the block B1 with respect to the film 300 is shorter than the distance of the block B2 with respect to the film 300, and the distance of the block B2 with respect to the film 300 is shorter than the distance of the block B3 with respect to the film 300. Accordingly, effects of classifying the main surface S1 of the workpiece 200 are also achieved.

In an embodiment illustrated in FIG. 2, a higher relative height in the mold cavity 400 indicates a closer distance with respect to the film 300. On the contrary, a lower relative height in the mold cavity 400 indicates a farther distance with respect to the film 300. However, this is only one of embodiments which matches the above two conditions at the same time. In an embodiment not illustrated, when the film 300 approaches the main surface S1 of the workpiece 200 but is not parallel to the bottom 410 (i.e., the film 300 is tilted with respect to the main surface S1 of the workpiece 200), the above two conditions could not match at the same time and have to be considered individually.

In addition, it should be mentioned that the main surface S1 is divided into the different blocks B1, B2, and B3, and numbers of the blocks are different according to the above classification conditions. The blocks B1, B2, and B3 of the present embodiment are exemplified, and are not used for limiting the invention.

With reference to FIG. 2 again, when the step S110 is completed, the film 300 substantially divides the mold cavity 400 into a first space P1 and a second space P2 as airtight spaces, respectively, and the workpiece 200 and the jig 100 are located in the second space P2. Next, a step S120 is carried out by heating the mold cavity 400 so as to increase temperatures of the space. Then, in a step S130, different negative pressures are provided into the second space P2 of the mold cavity 400 according to each of the blocks B1, B2 or B3, such that the film 300 is attached to and vacuumed onto the blocks B1, B2, and B3 of the main surface S1 in sequence. In the meantime, when the film 300 is vacuumed onto one of the blocks, a pattern is transfer printed from the film 300 onto the vacuumed block of the main surface S1. The described means such as heating or providing negative pressures may be achieved by connecting a vacuum unit 500 and a heating unit 600 with the mold cavity 400. Namely, in practical operations, a user may adopt a controller (not shown) for electrically connecting the vacuum unit 500 and the heating unit 600 so as to reach a purpose of heating or providing negative pressures into the mold cavity 400.

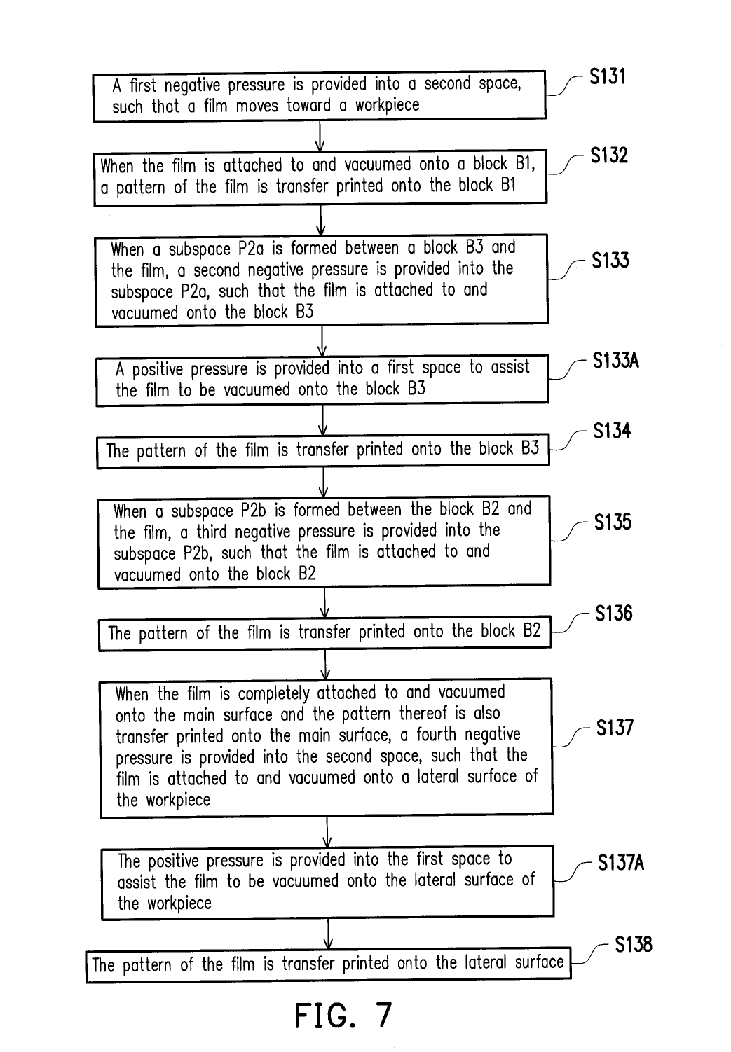

FIG. 7 is a detailed flow chart illustrating the step S130 of the manufacturing process depicted in FIG. 1. With reference to FIG. 7 and in comparison with FIG. 2 to FIG. 6, as described above, the workpiece 200 of the present embodiment is divided into the plurality of blocks B1, B2, and B3 due to a feature of a surface profile thereof. Thus, in a step S131, first, a first negative pressure V1 is provided into the second space P2, so that the film 300 may gradually and horizontally move toward the main surface S1 of the workpiece 200 (the moving direction is a negative direction of a Z axis as shown in FIG. 2) from a state as shown in FIG. 2. Meanwhile, an alignment between the film 300 and the workpiece 200 is carried out, so as to make sure that the pattern is accurately transfer printed onto a specific position of the workpiece 200.

Next, with reference to FIG. 2 and FIG. 3 together, when the first negative pressure V1 is continuously provided into the second space P2 for the film 300 to be attached to and vacuumed onto the block B1 of the main surface S1, a step S132 is executed to transfer print the pattern of the film 300 onto the block B1.

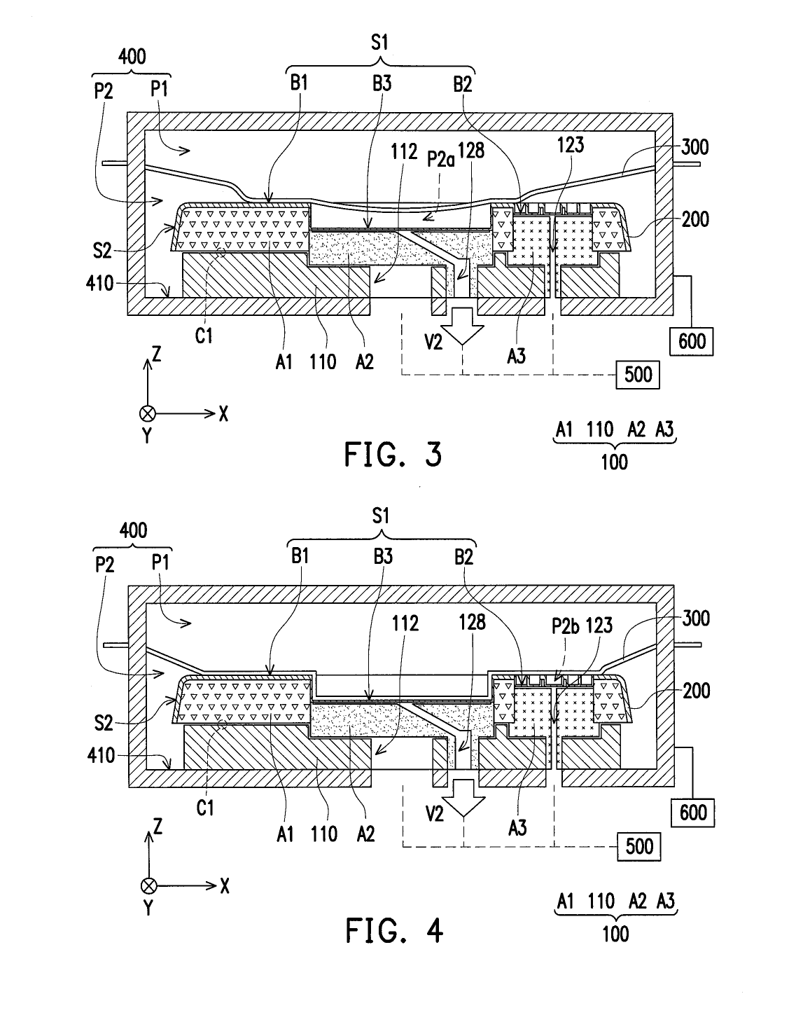

Furthermore, when the first negative pressure V1 is continuously provided, an airtight subspace P2a is also formed between the block B3 and the film 300 because the film 300 is vacuumed onto the block B1 of the main surface S1. As a result, at this time, in a step S133, a second negative pressure V2 is provided into the subspace P2a within the second space P2, such that the film 300 is further attached to the block B3 of the workpiece 200 to form a state as illustrated in FIG. 4. Thereafter, in a step S134, the pattern of the film 300 is transfer printed onto the block B3.

It should be mentioned that it is not necessary to execute the step S132 before the step S133. Namely, when executing the step S133, a process of transfer printing the pattern of the film 300 onto the block B1 could be continuously executed.

Moreover, when the subspace P2a is formed between the film 300 and the block B3, a pressure of the first space P1 is reduced due to an enlarged volume thereof. In order to allow the film 300 to be vacuumed onto the block B3 successfully, the manufacturing process for vacuum heat transfer printing further includes a step S133A, in which a positive pressure is provided into the first space P1 in order to increase the pressure of the first space P1 and assist the film 300 to be vacuumed onto the block B3 of the workpiece 200. In the meantime, it helps to extend the film 300.

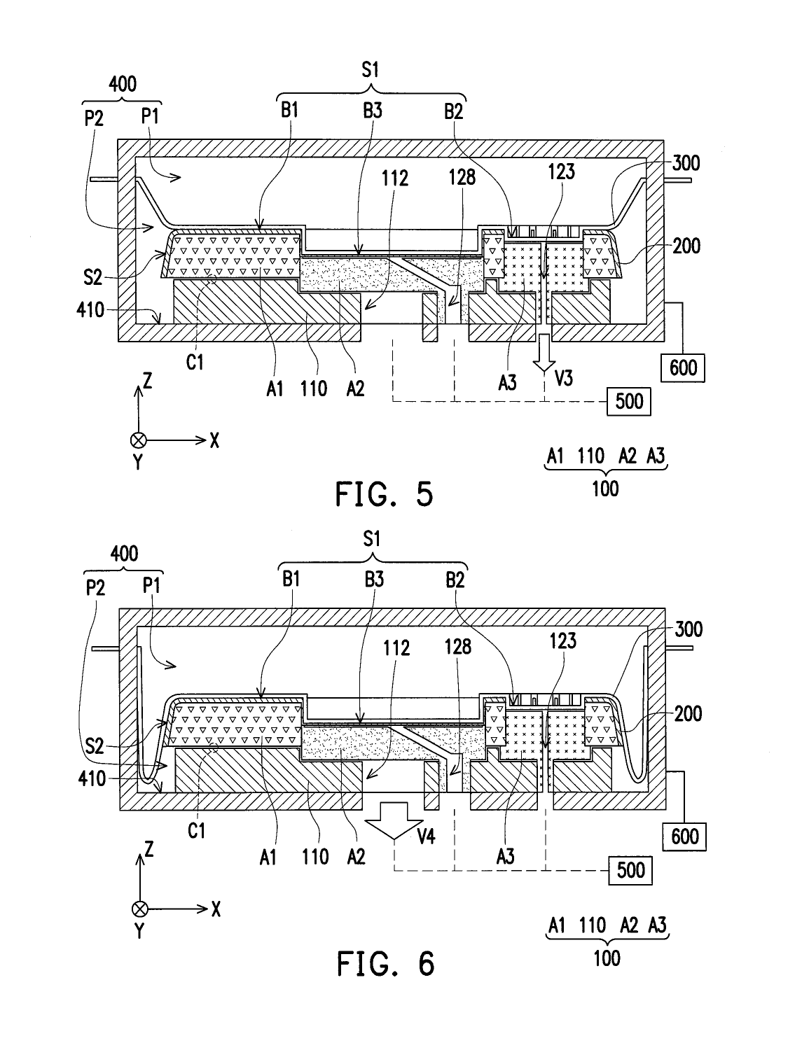

Similarly, when the second negative pressure V2 is continuously provided into the second space P2, an airtight subspace P2b is also formed between the film 300 and the block B2 because the film 300 is vacuumed onto the workpiece 200. As a result, at this time, in a step S135, a third negative pressure V3 is provided into the subspace P2b within the second space P2, such that the film 300 is attached to and vacuumed onto the block B2, as shown in FIG. 5. Thereafter, in a step S136, the pattern of the film 300 is then transfer printed onto the block B2.

Likewise, it is not necessary to execute the step S135 before the step S134. Namely, a process of providing the third negative pressure V3 into the subspace P2b and the manufacturing process for transfer printing the pattern as described in the step S134 could be executed at the same time.

Lastly, with reference to FIG. 5 and FIG. 6, the workpiece 200 further includes a lateral surface S2, which adjoins the main surface S1, and relative heights of the lateral surface S2 in the mold cavity 400 or distances with respect to the film 300 represent gradient changes (i.e., the lateral surface S2 substantially is in a tilting state compared to a horizontal state of the main surface S1). Accordingly, in a step S137, when the film 300 is completely attached to and vacuumed onto the main surface S1 and the pattern thereof is also transfer printed onto the main surface S1, a fourth negative pressure V4 is provided into the second space P2, such that the film 300 is attached to and vacuumed onto the lateral surface S2 of the workpiece 200. Thereafter, in a step S138, the pattern of the film 300 is transfer printed onto the lateral surface S2. With the reasons and effects similar to those of the step S133A, the manufacturing process for vacuum heat transfer printing further includes a step S137A, which provides a positive pressure into the first space P1 to assist the film 300 to be vacuumed onto the lateral surface S2 of the workpiece 200.

In light of the above, by providing the different negative pressures V1 to V4 into the mold cavity 400 according to a feature of an undulant surface of the workpiece 200, processes such as allowing the film 300 to be vacuumed onto and transfer printed onto the workpiece 200 may be optimized. Namely, by controlling the negative pressures which are provided into the mold cavity 400, the film 300 may correspond to the different blocks B1, B2, and B3 in a preferred way. Meanwhile, efficiency of the manufacturing process for vacuum heat transfer printing is also increased.

It is learned from the above embodiments that an order for providing the negative pressures in the manufacturing process is determined according to sizes of volume of the airtight second space P2 and the subspaces P2a and P2b which are formed between the film 300 and each of the blocks B1, B2, and B3 (i.e., negative pressures are correspondingly provided according to space capacity from large to small). Besides, in the above embodiment, the provided negative pressure is in direct proportion to sizes of volume of the corresponding second space P2 or subspaces P2a and P2b thereof.

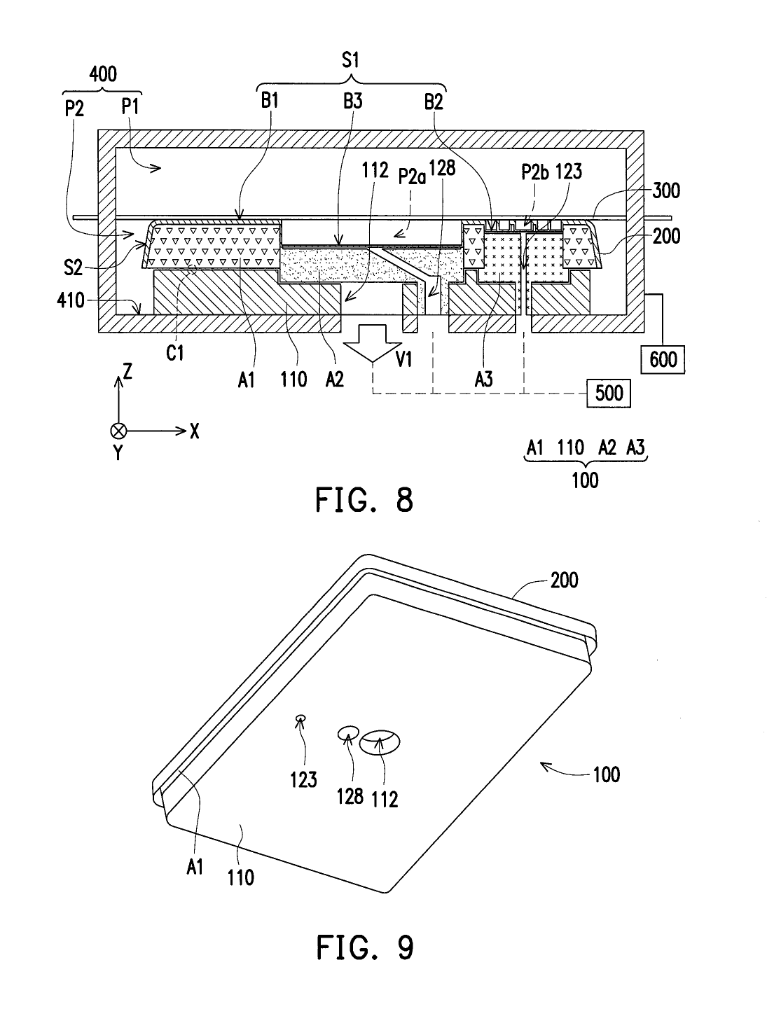

However, the invention is not limited thereto. FIG. 8 is a schematic view illustrating a manufacturing process for vacuum heat transfer printing in another embodiment of the invention. With reference to FIG. 8, when the first negative pressure V1 is provided into the mold cavity 400, the film 300 horizontally moves downward and is attached to and vacuumed onto the entire block B1. Accordingly, at this time, the airtight subspaces P2a and P2b are respectively formed between the film 300 and the blocks B2 and B3 at the same time. On this ground, in a subsequent step of the present embodiment, a user may determine to provide a negative pressure of a next stage into the at least one subspace. Namely, the provided negative pressures and the order of providing the negative pressures are determined according to features of each of the blocks. In other words, the invention does not limit the order of providing negative pressures into the divided blocks and degrees of the negative pressures.

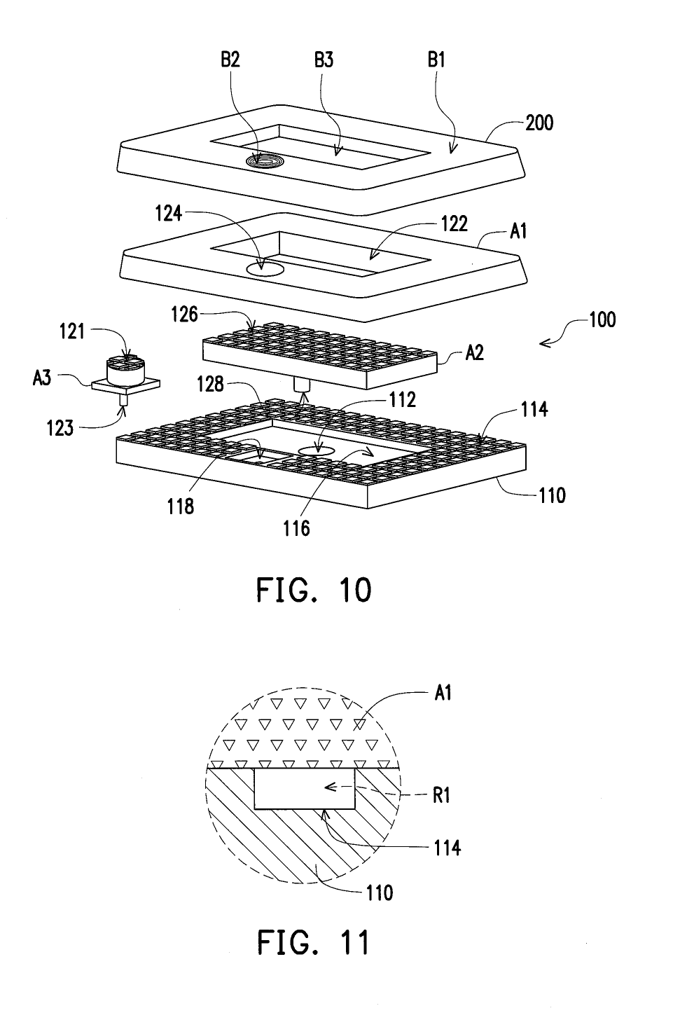

FIG. 9 is a schematic view illustrating a workpiece being carried on a jig depicted in FIG. 2. FIG. 10 is an exploded view illustrating the workpiece and the jig depicted in FIG. 9 from another viewing angle. With reference to FIGS. 9 and 10 and in comparison with FIG. 2, the jig 100 of the present embodiment includes a first component 110 and at least a second component. To be more specific, there exist second components A₁, A₂, and A₃ in the present embodiment. The first component 110 has a first outgassing aperture 112 and a plurality of first trenches 114 (a chessboard structure as illustrated in FIG. 10). The second components (A₁, A₂, A₃) may be detachably assembled to the first component 110.

FIG. 11 is a partial enlarged view of C1 depicted in FIG. 2. With reference to FIG. 2, FIG. 10 and FIG. 11 together, when the second components (A₁, A₂, A₃) are assembled to the first component 110, a plurality of air flues R1 are formed by the first trenches 114 and the second components (A₁, A₂, A₃). Besides, it is learned from FIG. 2 that the air flues R1 are connected to the first outgassing aperture 112, and the first outgassing aperture 112 may be further connected to the vacuum unit 500. Accordingly, when the workpiece 200 is carried on the second component (A₁) of the jig 100, the negative pressure provided by the vacuum unit 500 may be provided into the mold cavity 400 through the first outgassing aperture 112 and the air flues R1, so as to achieve effects of allowing the film 300 to be attached to the workpiece 200.

Similar to the workpiece 200, the second components (A₁, A₂, A₃) of the present embodiment deemed as carrying members respectively correspond to the blocks B1, B2, and B3 of the workpiece 200 according to relative heights thereof in the mold cavity 400. Namely, relative heights of the second components (A₁, A₂, A₃) with respect to the bottom 410 of the mold cavity 400 are also deemed as a dividing basis, such that the second components (A₁, A₂, A₃) may correspond to the same block having the same height. That is to say, a block having higher relative height corresponds to the second component also having a higher relative height. For example, the second component A₁ corresponds to the block B1, the second component A₂ corresponds to the block B3, and the second component A₃ corresponds to the block B2. Accordingly, the second components (A₁, A₂, A₃) successfully support the corresponding blocks B1, B3, and B2 of the workpiece 200.

As described above, the invention does not limit a manner of dividing the different blocks B1, B2, and B3 of the workpiece 200. Therefore, the second components (A₁, A₂, A₃) of the present embodiment may also be divided according to distances thereof with respect to the film 300. A manner of classification thereof may be referred to the manner of classifying the workpiece 200 as described above, and is not reiterated herein.

In details, with reference to FIG. 2 and FIG. 10 again, the second component A₁ of the present embodiment has a first opening 122 and a second opening 124. The second component A₂ is detachably assembled to the first component 110 and accommodated in the first opening 122, while the second component A₃ is detachably assembled to the first component 110 and accommodated in the second opening 124. The second component A₂ has a plurality of second trenches 126 and a second outgassing aperture 128 connecting to the vacuum unit 500, while the second component A₃ has a plurality of third trenches 121 and a third outgassing aperture 123 connecting to the vacuum unit 500, wherein the second outgassing aperture 128 and the third outgassing aperture 121 respectively pass through the first component 110. In addition, the second components A₂ and A₃ are respectively accommodated in recesses 116 and 118 of the first component 110, such that the second components (A₁, A₂, A₃) may respectively correspond to the different blocks B1, B3, and B2 of the workpiece 200. Furthermore, when the workpiece 200 is carried on the jig 100, the second trench 126 and the block B3 of the workpiece 200 form an air flue, and the third trench 121 and the block B2 of the workpiece form an air flue, so as to be used for providing corresponding negative pressures. Structures of related air flues are similar to those of FIG. 11, and are not iterated herein.

Besides, as shown in FIG. 2A, in the assembled second components (A₁, A₂, A₃), the second trench 126 presenting at a top surface of the second component A₂ is substantially lower than a top surface of the second component A₁, so as to correspond to the block B3 of the workpiece 200; and the third trench 121 presenting at a top surface of the second component A₃ is substantially lower than the top surface of the second component A₁, so as to correspond to the block B2 of the workpiece. Accordingly, when the first negative pressure V1 is provided into the second space P2 of the mold cavity 400 and allows the film 300 to be attached to and vacuumed onto the block B1 (as shown in FIG. 3), an airtight space is substantially formed between the film 300 and the second component A₂. Accordingly, the second negative pressure V2 is then provided by the vacuum unit 500 to the subspace P2a through the second outgassing aperture 128 and the second trench 126, so as to allow the film 300 to be further attached to and vacuumed onto the block B3. Similarly, when the second negative pressure V2 is provided into the second space P2 of the mold cavity 400 and allows the film 300 to be attached to and vacuumed onto the block B3 (as shown in FIG. 5), an airtight space is substantially formed between the film 300 and the second component A₂. Accordingly, the third negative pressure V3 is then provided by the vacuum unit 500 to the subspace P2b through the third outgassing aperture 123 and the third trench 121, so as to allow the film 300 to be further attached to and vacuumed onto the block B2.

In light of the above, the jig 100 is applied in the mold cavity 400 for the manufacturing process for vacuum heat transfer printing. In addition to be deemed as a carrying member of the workpiece 200, the jig 100 may correspond to each of the blocks of the workpiece 200 by a combination of different components, and thereby coordinating with the above and providing negative pressures into the different blocks of the mold cavity 400. Then, efficiency of the manufacturing process is increased.

In summary, in the above embodiments of the invention, in order to cope with different profiles with various degrees of undulation which are presented on a main surface of a workpiece, the embodiments divide the main surface of the workpiece into a plurality of blocks in the manufacturing process for vacuum heat transfer printing, and further provides corresponding negative pressures to each of the blocks by coordinating with a jig having a combination of different components at the same time. In order to be deemed as a carrying member of the workpiece, the jig may correspond to each of the blocks of the workpiece, such that different negative pressures may be provided into the mold cavity successfully and allow a film to be attached to and vacuumed onto the blocks of the workpiece, and a pattern to be gradually transfer printed onto the main surface so as to optimize efficiency of the manufacturing process.

Although the invention has been disclosed with reference to the aforesaid embodiments, they are not intended to limit the invention. It will be apparent to those skilled in the art that various modifications and variations can be made to the structure of the disclosed embodiments without departing from the scope or spirit of the invention. In view of the foregoing, it is intended that the disclosure cover modifications and variations of the specification provided they fall within the scope of the following claims and their equivalents.

Although the invention has been disclosed with reference to the aforesaid embodiments, they are not intended to limit the invention. It will be apparent to those skilled in the art that various modifications and variations can be made to the structure of the disclosed embodiments without departing from the scope or spirit of the invention. In view of the foregoing, it is intended that the disclosure cover modifications and variations of the specification provided they fall within the scope of the following claims and their equivalents.

What is claimed is:

1. A manufacturing process for vacuum heat transfer printing, used for transfer printing a pattern of a film onto a workpiece, the manufacturing process for vacuum heat transfer printing comprising:
disposing the workpiece and the film in a mold cavity, the film located above a main surface of the workpiece, wherein the main surface is divided into a plurality of blocks;
heating the mold cavity; and
providing different negative pressure into the mold cavity by corresponding to each of the blocks, such that the film is vacuumed onto the blocks in sequence and the pattern is transfer printed onto the main surface of the workpiece in sequence.

2. The manufacturing process for vacuum heat transfer printing as claimed in claim 1, wherein the main surface is divided into the plurality of blocks according to relative heights thereof in the mold cavity, and portions of the main surface located in the same block have the same relative height.

3. The manufacturing process for vacuum heat transfer printing as claimed in claim 1, wherein the main surface is divided into the plurality of blocks according to distances with respect to the film, and portions of the main surface located in the same block have the same distance with respect to the film.

4. The manufacturing process for vacuum heat transfer printing as claimed in claim 1, wherein the film divides the mold cavity into a first space and a second space, the workpiece is located in the second space, the negative pressures are provided into the second space.

5. The manufacturing process for vacuum heat transfer printing as claimed in claim 4, wherein the main surface comprises a first block and a second block, the manufacturing process for vacuum heat transfer printing further comprises:
providing a first negative pressure into the second space, such that the film is vacuumed onto the first block and the pattern is transfer printed onto the first block, wherein the second block and the film form a subspace; and
providing a second negative pressure into the subspace, such that the film is vacuumed onto the second block and the pattern is transfer printed onto the second block.

6. The manufacturing process for vacuum heat transfer printing as claimed in claim 5, wherein the second space and the subspace are airtight space, respectively.

7. The manufacturing process for vacuum heat transfer printing as claimed in claim 4, further comprising:
providing a positive pressure into the first space to assist the film to be vacuumed onto the workpiece.

8. The manufacturing process for vacuum heat transfer printing as claimed in claim 4, when the negative pressures are provided into the second space, the film is vacuumed onto and transfer prints the pattern onto one of the blocks of the main surface, and a plurality of subspaces are formed by the film and other non-vacuumed blocks, the manufacturing process for vacuum heat transfer printing further comprises:
providing different negative pressures into the subspaces according to sizes of each of the subspaces, such that the film is vacuumed onto the corresponding blocks and the pattern is transfer printed onto the blocks.

9. The manufacturing process for vacuum heat transfer printing as claimed in claim 8, further comprising:
providing different negative pressure into the subspaces in sequence according to the sizes of each of the subspaces from large to small.

10. The manufacturing process for vacuum heat transfer printing as claimed in claim 8, wherein the second space and the subspaces are airtight space, respectively.

11. The manufacturing process for vacuum heat transfer printing as claimed in claim 8, wherein the provided negative pressures are directly proportional to the sizes of the subspaces.

12. The manufacturing process for vacuum heat transfer printing as claimed in claim 1, wherein the workpiece further comprises at least a lateral surface adjoining to the main surface, and relative heights of the lateral surface in the mold cavity or distances with respect to the film represent gradient changes, the manufacturing process for vacuum heat transfer printing further comprises:
providing another negative pressure after the film is vacuumed onto and transfer printed a pattern onto the main surface of the workpiece, such that the film is vacuumed onto and transfer printed the pattern onto the lateral surface of the workpiece.

13. The manufacturing process for vacuum heat transfer printing as claimed in claim 12, wherein the film divides the mold cavity into a first space and a second space, the workpiece is located in the second space, the negative pressure is provided into the second space, the manufacturing process for vacuum heat transfer printing further comprises:
providing a positive pressure into the first space to assist the film to be vacuumed onto the lateral surface of the workpiece.

14. A jig adapted for the manufacturing process for vacuum heat transfer printing as claimed in claim 1, used for transfer printing a pattern of a film onto a main surface of a workpiece, the jig disposed in a mold cavity for the manufacturing process for vacuum heat transfer printing, the jig comprising:
a first component having a first outgassing aperture and a plurality of first trenches; and
at least a second component detachably assembled to the first component, such that the first trench and the second component form a plurality of air flues connecting to the first outgassing aperture, the workpiece being adapted to be carried on the second component, a vacuum unit being adapted to be connected to the first outgassing aperture and the vacuum unit providing negative pressures into the mold cavity through the first outgassing aperture and the air flues, such that the film is attached to the plurality of blocks of the workpiece.

15. The jig as claimed in claim 14, wherein the main surface is divided into the plurality of blocks according to relative heights thereof in the mold cavity, and portions of the main surface located in the same block have the same relative height, and the jig comprises the plurality of second components, the second components respectively correspond to the blocks according to the relative heights thereof in the mold cavity.

16. The jig as claimed in claim 14, wherein the main surface is divided into the plurality of blocks according to distances with respect to the film, and portions of the main surface located in the same block have the same distance with respect to the film, and the jig comprises the plurality of second components, the second components respectively correspond to the blocks according to the distances with respect to the film.

17. The jig as claimed in claim 14, comprising a plurality of second components (A₁, A₂), wherein the second component (A₁) has a first opening, the second component (A₂) is detachably assembled to the first component and accommodated in the first opening, wherein the second component (A₂) has a plurality of second trenches and a second outgassing aperture connecting to the vacuum unit, the second outgassing aperture passes through the first component, and the second components (A₁, A₂) respectively correspond to different blocks of the workpiece.

18. The jig as claimed in claim 17, wherein a relative height of the second component (A₂) in the mold cavity is lower than a relative height of the second component (A₁) in the mold cavity, or a distance of the film with respect to the second component (A₁) is shorter than a distance of the film with respect to the second component (A₂), when the film is attached to the second component (A₁), an airtight space between the film and the second component (A₂) is formed.

19. The jig as claimed in claim 14, comprising a plurality of second components (A₁, A₂, A₃), wherein the second component (A₁) has a first opening and a second opening, the second component (A₂) is detachably assembled to the first component and accommodated in the first opening, the second component (A₃) is detachably assembled to the first component and accommodated in the second opening, the second component (A₂) has a plurality of second trenches and a second outgassing aperture connecting to the vacuum unit, the second component (A₃) has a plurality of third trenches and a third outgassing aperture connecting to the vacuum unit, the second and third outgassing apertures respectively pass through the first component, and the second components (A₁, A₂, A₃) respectively correspond to different blocks of the workpiece.

20. The jig as claimed in claim 19, wherein a relative height of the second component (A₂) in the mold cavity is lower than a relative height of the second component (A₁) in the mold cavity, or a distance of the film with respect to the second component (A₁) is shorter than a distance of the film with respect to the second component (A₂), and a relative height of the second component (A₃) in the mold cavity is lower than the relative height of the second component (A₂) in the mold cavity, or the distance of the film with respect to the second component (A₂) is shorter than a distance of the film with respect to the second component (A₃), when the film is attached to the second component (A₁), an airtight space between the film and the second component (A₂) is formed, and the film is attached to the second component (A₂), an airtight space between the film and the second component (A₃) is formed.
